(19) United States
(12) Patent Application Publication
(10) Pub. No.: US 2014/0007098 A1
(43) Pub. Date: Jan. 2, 2014

(54) PROCESSOR ACCELERATOR INTERFACE VIRTUALIZATION

(71) Applicants: Paul M. Stillwell, JR., Aloha, OR (US); Omesh Tickoo, Portland, OR (US); Vineet Chadha, Hillsboro, OR (US); Yong Zhang, Hillsboro, OR (US); Rameshkumar G. Illikkal, Portland, OR (US); Ravishankar Iyer, Portland, OR (US)

(72) Inventors: Paul M. Stillwell, JR., Aloha, OR (US); Omesh Tickoo, Portland, OR (US); Vineet Chadha, Hillsboro, OR (US); Yong Zhang, Hillsboro, OR (US); Rameshkumar G. Illikkal, Portland, OR (US); Ravishankar Iyer, Portland, OR (US)

(21) Appl. No.: 13/997,379

(22) PCT Filed: Dec. 28, 2011
(86) PCT No.: PCT/US11/67560

§ 371 Date: Jun. 24, 2013

(51) Int. Cl. G06F 9/455

(52) U.S. Cl. CPC G06F 9/455
USPC 718/1; 712/220

(57) ABSTRACT

Embodiments of apparatuses and methods for processor accelerator interface virtualization are disclosed. In one embodiment, an apparatus includes instruction hardware and execution hardware. The instruction hardware is to receive instructions. One of the instruction types is an accelerator job request instruction type, which the execution hardware executes to cause the processor to submit a job request to an accelerator.

### BACKGROUND

1. Field

The present disclosure pertains to the field of information processing, and more particularly, to the field of virtualizing resources in information processing systems.

2. Description of Related Art

Generally, the concept of virtualization of resources in information processing systems allows a physical resource to be shared by providing multiple virtual instances of the physical resource. For example, a single information processing system may be shared by one or more operating systems (each, an “OS”), even though each OS is designed to have complete, direct control over the system and its resources. System level virtualization may be implemented by using software (e.g., a virtual machine monitor, or “VMM”) to present to each OS a “virtual machine” (“VM”) having virtual resources, including one or more virtual processors, that the OS may completely and directly control, while the VMM maintains a system environment for implementing virtualization policies such as sharing and/or allocating the physical resources among the VMs (the “virtualization environment”). Each OS, and any other software, that runs on a VM is referred to as a “guest” or as “guest software,” while a “host” or “host software” is software, such as a VMM, that runs outside of the virtualization environment.

A physical processor in an information processing system may support virtualization, for example, by operating in two modes—a “root” mode in which software runs directly on the hardware, outside of any virtualization environment, and a “non-root” mode in which software runs at its intended privilege level on a virtual processor (i.e., a physical processor executing under constraints imposed by a VMM) in a VM, within a virtualization environment hosted by a VMM running in root mode. In the virtualization environment, certain events, operations, and situations, such as external interrupts or attempts to access privileged registers or resources, may be intercepted, i.e., cause the processor to exit the virtualization environment so that the VMM may operate, for example, to implement virtualization policies (a “VM exit”). A processor may support instructions for establishing, entering, exiting, and maintaining a virtualization environment, and may include register bits or other structures that indicate or control virtualization capabilities of the processor.

A physical resource in the system, such as a hardware accelerator, an input/output device controller, or another peripheral device, may be assigned or allocated to a VM on a dedicated basis. Alternatively, a physical resource may be shared by multiple VMs according to a more software-based approach, by intercepting all transactions involving the resource so that the VMM may perform, redirect, or restrict each transaction. A third, more hardware-based approach may be to design a physical resource to provide the capability for it to be used as multiple virtual resources.

### BRIEF DESCRIPTION OF THE FIGURES

The present invention is illustrated by way of example and not limitation in the accompanying figures.

FIG. 1 illustrates a system in which an embodiment of the present invention may be present and/or operate.

FIG. 2 illustrates a processor supporting processor accelerator interface virtualization according to an embodiment of the present invention.

FIG. 3 illustrates a virtualization architecture in which an embodiment of the present invention may operate.

FIG. 4 illustrates a method for processor accelerator interface virtualization according to an embodiment of the present invention.

### DETAILED DESCRIPTION

Embodiments of processors, methods, and systems for processor accelerator interface virtualization are described below. In this description, numerous specific details, such as component and system configurations, may be set forth in order to provide a more thorough understanding of the present invention. It will be appreciated, however, by one skilled in the art, that the invention may be practiced without such specific details. Additionally, some well known structures, circuits, and the like have not been shown in detail, to avoid unnecessarily obscuring the present invention.

The performance of a virtualization environment may be improved by reducing the frequency of VM exits. Embodiments of the invention may provide an approach to reducing the frequency of VM exits, compared to the more software-based approach to physical resource virtualization described above, without requiring the physical resource to support the more hardware-based approach described above.

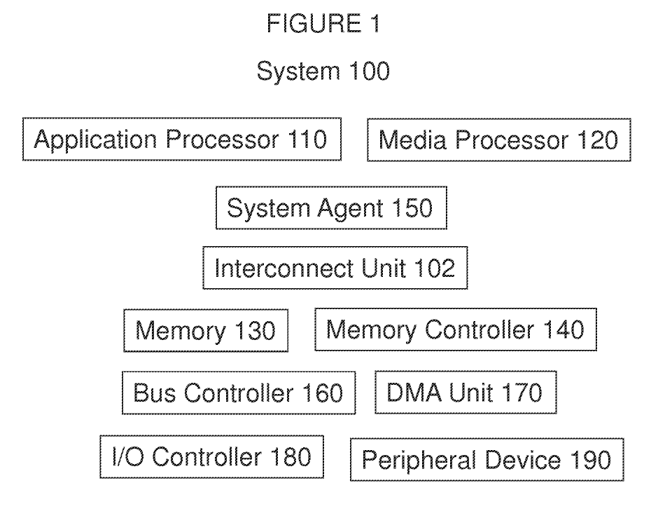

FIG. 1 illustrates system 100, an information processing system in which an embodiment of the present invention may be present and/or operate. System 100 may represent any type of information processing system, such as a server, a desktop computer, a portable computer, a set-top box, a hand-held device, or an embedded control system.

System 100 includes application processor 110, media processor 120, memory 130, memory controller 140, system agent unit 150, bus controller 160, direct memory access (“DMA”) unit 170, input/output controller 180, and peripheral device 190. Systems embodying the present invention may include any or all of these components or other elements, and/or any number of each component or other element, and any number of additional components or other elements. Multiple instances of any component or element may be identical or different (e.g., multiple instances of an application processor may all be the same type of processor or may be different types of processors). Any or all of the components or other elements in any system embodiment may be connected, coupled, or otherwise in communication with each other through interconnect unit 102, which may represent any number of buses, point-to-point, or other wired or wireless connections.

Systems embodying the present invention may include any number of these elements integrated onto a single integrated circuit (a “system on a chip” or “SOC”). Embodiments of present invention may be desirable in a system including an SOC because a known software-based approach to resource virtualization may not take advantage of the full performance benefit oaf having hardware accelerators on the same chip as the processor, and a known hardware-based approach may add to chip size, cost, and complexity. Furthermore, information regarding the context in which software is running may be available to the processor core executing the software, and this context information may be used in embodiments of the present invention to send job requests from by the processor core to accelerators and other resources on the same SOC as the processor core, using a standard interface that can be implemented by the architect or designer of the SOC.

Application processor 110 may represent any type of processor, including a general purpose microprocessor, such as a processor in the Core® Processor Family, the Atom® Processor Family, or other processor family from Intel Corporation, or another processor from another company, or any other processor for processing information according to an embodiment of the present invention. Application processor 110 may include any number of execution cores and/or support any number of execution threads, and therefore may represent any number of physical or logical processors, and/or may represent a multi-processor component or unit.

Media processor 120 may represent a graphics processor, an image processor, an audio processor, a video processor, and/or any other combination of processors or processing units to enable and/or accelerate the compression, decompression, or other processing of media or other data.

Memory 130 may represent any static or dynamic random access memory, semiconductor-based read only or flash memory, magnetic or optical disk memory, any other type of medium readable by processor 110 and/or other elements of system 100, or any combination of such mediums. Memory controller 140 may represent a controller for controlling access to memory 130 and maintaining its contents. System agent unit 150 may represent a unit for managing, coordinating, operating, or otherwise controlling processors and/or execution cores within system 100, including power management.

Communication controller 160 may represent any type of controller or unit for facilitating communication between components and elements of system 100, including, a bus controller or a bus bridge. Communication controller 160 may include system logic to provide system level functionality such as a clock and system level power management, or such system logic may be provided elsewhere within system 100. DMA unit 170 may represent a unit for facilitating direct access between memory 130 and non-processor components or elements of system 100. DMA unit 170 may include an I/O memory management unit (an “IOMMU”) to facilitate the translation of guest, virtual, or other addresses used by non-processor components or elements of system 100 to physical addresses used to access memory 130.

I/O controller 180 may represent a controller for an I/O or peripheral device, such as a keyboard, a mouse, a touchpad, a display, audio speakers, or an information storage device, according to any known dedicated, serial, parallel, or other protocol, or a connection to another computer, system, or network. Peripheral device 190 may represent any type of I/O or peripheral device, such as a keyboard, a mouse, a touchpad, a display, audio speakers, or an information storage device.

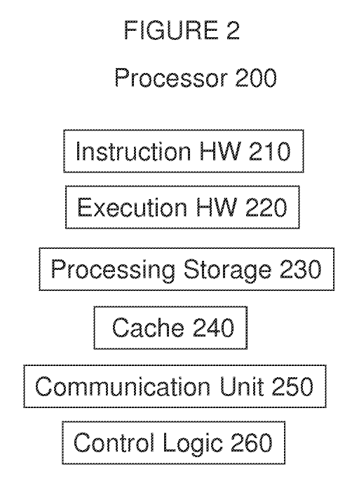

FIG. 2 illustrates processor 200, which may represent application processor 110 in FIG. 1, according to an embodiment of the present invention. Processor 200 may include instruction hardware 210, execution hardware 220, processing storage 230, cache 240, communication unit 250, and control logic 260, with any combination of multiple instance of each.

Instruction hardware 210 may represent any circuitry, structure, or other hardware, such as an instruction decoder, for fetching, receiving, decoding, and/or scheduling instructions, including the novel instructions according to embodiments of the invention described below. Any instruction format may be used within the scope of the present invention; for example, an instruction may include an opcode and one or more operands, where the opcode may be decoded into one or more micro-instructions or micro-operations for execution by execution hardware 220. Execution hardware 220 may include any circuitry, structure, or other hardware. such as an arithmetic unit, logic unit, floating point unit, shifter, etc., for processing data and executing instructions, micro-instructions, and/or micro-operations.

Processing storage 230 may represent any type of storage usable for any purpose within processor 200, for example, it may include any number of data registers, instruction registers, status registers, other programmable or hard-coded registers or register files, data buffers, instruction buffers. address translation buffers, branch prediction buffers, other buffers, or any other storage structures. Cache 240 may represent any number of level(s) of a cache hierarchy including caches to store data and/or instructions and caches dedicated per execution core and/or caches shared between execution cores.

Communication unit 250 may represent any circuitry, structure, or other hardware, such as an internal bus, an internal bus controller, an external bus controller, etc., for moving data and/or facilitating data transfer among the units or other elements of processor 200 and/or between processor 200 and other system components and elements.

Control logic 260 may represent microcode, programmable logic, hard-coded logic, or any other type of logic to control the operation of the units and other elements of processor 200 and the transfer of data within processor 200. Control logic 260 may cause processor 200 to perform or participate in the performance of method embodiments of the present invention, such as the method embodiments described below, for example, by causing processor 200 to execute instructions received by instruction hardware 210 and micro-instructions or micro-operations derived from instructions received by instruction hardware 210.

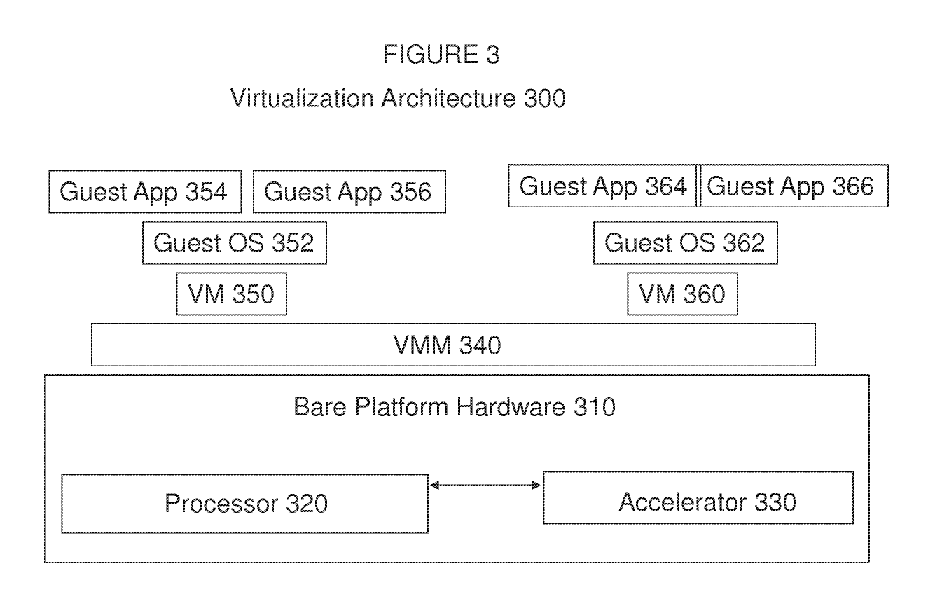

FIG. 3 illustrates virtualization architecture 300, in which an embodiment of the present invention may be present and/or operate. In FIG. 3, bare platform hardware 310 may represent any information processing system, such as system 100 of FIG. 1 or any portion of system 100. FIG. 3 shows processor 320, which may correspond to an instance of application processor 110 of FIG. 1 or any processor or execution core within any multi-processor or multi-core instance of application processor 110. FIG. 3 also shows accelerator 330, where the term “accelerator” may be used to refer to an instance of a media processor such as media processor 120, or any processing unit, accelerator, co-processor, or other functional unit within an instance of a media processor, or any other component, device, or element capable of communicating with processor 320 according to an embodiment of the present invention.

Additionally, FIG. 3 shows VMM 340, which represents any software, firmware, or hardware host or hypervisor installed on or accessible to bare platform hardware 310, to present VMs, i.e., abstractions of bare platform hardware 310, to guests, or to otherwise create VMs, manage VMs, and implement virtualization policies. A guest may be any OS, any VMM, including another instance of VMM 340, any hypervisor, or any application or other software. Each guest expects to access physical resources, such as processor and platform registers, memory, and input/output devices, of bare platform hardware 310, according to the architecture of the processor and the platform presented in the VM. FIG. 3 shows VMs 350 and 360, with guest OS 352 and guest applications 354 and 356 installed on VM 350 and with guest OS 362 and guest applications 364 and 366 installed on VM 360. Although FIG. 3 shows two VMs and six guests, any number of VMs may be created and any number of guests be installed on each VM within the scope of the present invention.

A resource that may be accessed by a guest may either be classified as a “privileged” or a “non-privileged” resource. For a privileged resource, a host (e.g., VMM 340) facilitates the functionality desired by the guest while retaining ultimate control over the resource. Non-privileged resources do not need to be controlled by the host and may be accessed directly by a guest.

Furthermore, each guest OS expects to handle various events such as exceptions (e.g., page faults and general protection faults), interrupts (e.g., hardware interrupts and software interrupts), and platform events (e.g., initialization and system management interrupts). These exceptions, interrupts, and platform events are referred to collectively and individually as “events” herein, Some of these events are “privileged” because they must be handled by a host to ensure proper operation of VMs, protection of the host from guests, and protection of guests from each other.

At any given time, processor 320 may be executing instructions from VMM 340 or any guest, thus VMM 340 or the guest may be active and running on, or in control of, processor 320. When a privileged event occurs while a guest is active or when a guest attempts to access a privileged resource, a VM exit may occur, transferring control from the guest to VMM 340. After handling the event or facilitating the access to the resource appropriately, VMM 340 may return control to a guest. The transfer of control from a host to a guest (including an initial transfer to a newly created VM) is referred to as a “VM entry” herein. An instruction that is executed to transfer control to a VM may be referred to generically as a “VM enter” instruction, and, for example, may include a VMLAUCH and a VMRESUME instruction in the instruction set architecture of a processor in the Core® Processor Family.

Embodiments of the present invention may use instruction of a first novel instruction type and a second novel instruction type, referred to as an accelerator identification instruction and an accelerator job request instruction, respectively. These instruction types may be realized in any desired format, according to the conventions of the instruction set architecture of any processor or processor family. These instructions may be used by any software executing on any processor that supports an embodiment of the present invention, and may desirable because they provide for guest software executing in a VM on a processor to make use of an accelerator without causing a VM exit, even when the accelerator is not dedicated to that VM or designed with a hardware interface to provide for its use as one of multiple virtual instances of the accelerator.

An accelerator identification instruction may be used to identify and/or enumerate the accelerators, such as accelerator 330, available for job requests from a processor core, such as processor 320. For example, the accelerator identification (“ID”) instruction may be a variation of the CPUID instruction in the instruction set architecture of the Intel® Core® Processor Family. The accelerator ID instruction may be executed on the processor core, and in response, the processor core may provide information regarding one or more accelerators to which it may issue job requests. The information may include information regarding the identity, functionality, number, topology, and other features of the accelerator(s). The information may be provided by returning it to or storing it in a particular location in a processor register or elsewhere in processing storage 230 or system 100. The information may be available to the processor core because it is stored in a processor register, an accelerator register, a system register, or elsewhere in the processor, accelerator, or system, by basic input/output system software, other system configuration software, other software, and/or by the processor, accelerator, or system designer, fabricator, or vendor. The accelerator ID instruction may return the information for a single accelerator, in which case it may be used to determine the information for any number of accelerators by issuing it any number of times, separately or in sequence, and/or may return the information for any number of accelerators.

An accelerator job request instruction may be used to send a job requests from a processor core, such as processor 320, to an accelerator, such as accelerator 330. An accelerator job request instruction may include or provide a reference to an accelerator ID value, which may be a value to identify an accelerator to which the request is being made. The accelerator ID value may be a value that has been returned by the execution of an accelerator ID instruction. An accelerator job request instruction may also include or indirectly provide any other information necessary or desired to submit a job request, such as a request or operation type. The execution of an accelerator job request instruction may return a transaction ID value, which may be assigned by the processor core and may be used by the requesting software to refer to the job request to track its execution, completion, and results.

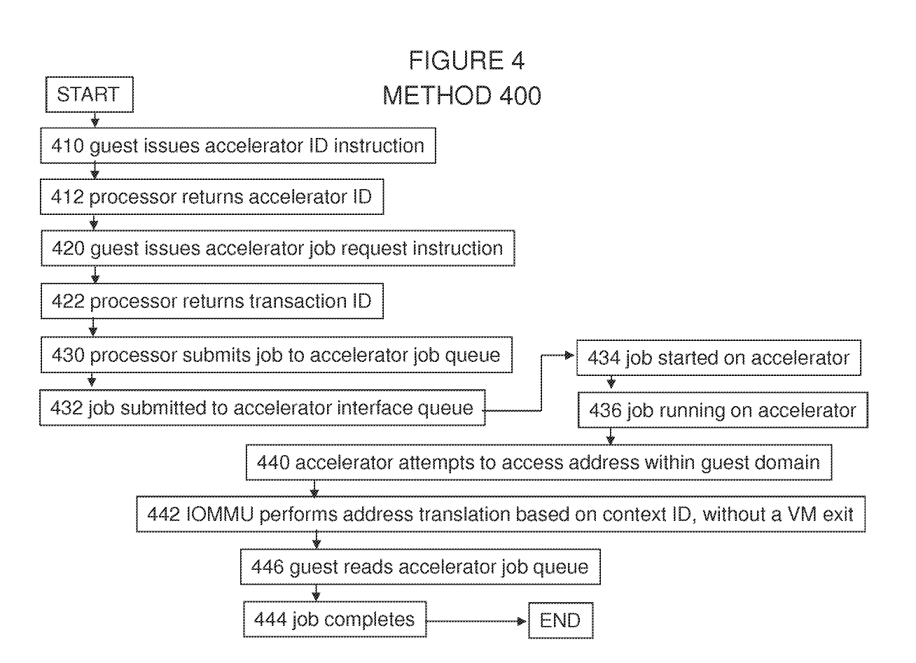

FIG. 4 illustrates method 400 for processor accelerator interface virtualization according to an embodiment of the present invention. The description of FIG. 4 may refer to elements of FIGS. 1, 2, and 3 but method 400 and other method embodiments of the present invention are not intended to be limited by these references.

In box 410, software (e.g., guest OS 352) running in a VM (e.g., 350) on a processor core (e.g., processor 320), issues an accelerator ID instruction. In box 412, processor 320 returns accelerator identification information, including the ID value of an accelerator e.g., accelerator 330).

In box 420, guest OS 352 issues an accelerator job request instruction, including the ID value of accelerator 320. In box 422, processor 320 returns a transaction ID corresponding to the job requested in box 420.

In box 430, processor 320 submits the job to an accelerator job queue, along with the transaction ID, an application context ID, and a “to do” status. The accelerator job queue may be used to track all jobs on all accelerators in the system, and may be implemented as a ring buffer or any other type of buffer or storage structure within processing storage 230, cache 240, and/or memory 130. The accelerator job queue may contain any number of entries, wherein each entry may include the transaction ID, the accelerator ID, the context ID, a processing state (e.g., run, wait, etc.), a command value, and/or a status (e.g., to do, running, done).

The context ID may be used by the accelerator to identify the application context, so that the accelerator may be used by multiple guests running in multiple VMs with fewer VM exits. For example, the context ID may be used for address translation by an IOMMU without the need for a VM exit to enforce address domain isolation.

In box 432, the job may be submitted to an interface queue for a particular accelerator. In box 434, the, job may be started on the accelerator, and the status changed to running in the job queue. In box 436, the job may be running on the accelerator.

In box 440, the accelerator attempts to access an address within the address domain corresponding to the context ID. In box 442, an address translation for the job, for example from an address within the address domain corresponding to the context ID to a physical address in memory 130, may be performed by an IOMMU, using the context ID to enforce address domain isolation, without causing a VM exit. In box 444, the job may be completed on the accelerator, and the status changed to done in the job queue. In box 446, guest OS 352 may read the job queue to determine that the job is complete.

Within the scope of the present invention, method 400 may be performed in a different order than that shown in FIG. 4, with illustrated boxes omitted, with additional boxes added, or with a combination of reordered, omitted, or additional boxes.

Thus, processors, methods, and systems for processor accelerator interface virtualization have been disclosed. While certain embodiments have been described. and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising:
instruction hardware to receive a plurality of instructions, each having one of a plurality of instruction types, including an accelerator job request instruction type; and
execution hardware to execute the accelerator job request instruction type to cause the processor to submit a job request to an accelerator and return a transaction identification value.

2. The processor of claim 1, wherein the processor is connected to the accelerator on a system on a chip.

3. The processor of claim 1, wherein the accelerator job request instruction type includes an accelerator identifier field.

4. The processor of claim 3, wherein the plurality of instruction types also includes an accelerator identification instruction type, and the execution hardware is to execute the accelerator identification instruction type to cause the processor to provide a value for the accelerator identifier field identification.

5. The processor of claim 1, wherein the plurality of instruction types also includes a virtual machine enter instruction type, and the execution hardware is to execute the virtual machine entry instruction type to cause the processor to transfer from a root mode to a non-root mode for executing guest software in at least one virtual machine, wherein the processor is to return to the root mode upon the detection of any of a plurality of virtual machine exit events, and wherein the processor is to execute the accelerator job request instruction type without causing a virtual machine exit.

6. The processor of claim 1, further comprising storage to store an accelerator job queue, the accelerator job queue having a plurality of entry locations, each entry location to store a transaction identifier, an accelerator identifier, a context identifier, and a status.

7. A method comprising:
receiving, by a processor, a first instruction, the first instruction having an accelerator job request instruction type; and
executing, by the processor, the first instruction to subunit a job request to an accelerator.

8. The method of claim wherein the processor is connected to the accelerator on a system on a chip.

9. The method of claim 7, further comprising identifying the accelerator from a value in a field of the first instruction.

10. The method of claim 7, further comprising:
receiving, by the processor, a second instruction, the second instruction having accelerator identification instruction type; and
executing, by the processor, the second instruction to cause the processor to provide identification information for an accelerator to accept a job request.

11. The method of claim 7, further comprising:
receiving, by the processor, a third instruction, the third instruction having a virtual machine enter instruction type; and
executing, by the processor, the third instruction to cause the processor to transfer from a root mode to a non-root mode for executing guest software in at least one virtual machine, wherein the processor is to return to the root mode upon the detection of any of a plurality of virtual machine exit events, and wherein the processor is to execute the accelerator job request instruction type without causing a virtual machine exit.

12. The method of claim 7, further comprising returning, by the processor, a transaction identifier in response to receiving the first instruction.

13. The method of claim 7, further comprising submitting, by the processor, the job request to an accelerator job queue.

14. The method of claim 13, further comprising submitting, by the processor, a context identifier to the accelerator job queue.

15. The method of claim 14, further comprising translating, by an input/output memory management unit, an address for the job request.

16. The method of claim 15, further comprising using the context identifier to enforce address domain isolation without causing a virtual machine exit.

17. A system comprising:
a hardware accelerator; and
a processor including
instruction hardware to receive a plurality of instructions, each having one of a plurality of instruction types, including an accelerator job request instruction type, and
execution hardware to execute the accelerator job request instruction type to cause the processor submit a job request to the hardware accelerator and return a transaction identification value.

18. The system of claim 17, wherein the plurality of instruction types also includes an accelerator identification instruction type, and the execution hardware is to execute the accelerator identification instruction type to cause the processor to provide an identification information associated with the accelerator.

19. The system of claim 17, wherein the plurality of instruction types also includes a virtual machine enter instruction type, and the execution hardware is to execute the virtual machine entry instruction type to cause the processor to transfer from a root mode to a non-root mode for executing guest software in at least one virtual machine, wherein the processor is to return to the root mode upon the detection of any of a plurality of virtual machine exit events.

20. The system of claim 19, further comprising an input/output memory management unit to translate an address for the job request using a context identifier to enforce address domain isolation without causing a virtual machine exit, the context identifier provided by the processor to the accelerator in connection with the job request.
